(19) United States
(12) Patent Application Publication
(10) Pub. No.: US 2025/0061639 A1
(43) Pub. Date: Feb. 20, 2025

(54) HAIR DESIGN AND RENDERING

(71) Applicant: Roblox Corporation, San Mateo, CA (US)

(72) Inventors: Tom SANOCKI, San Mateo, CA (US); Alban Wood, San Mateo, CA (US); Jovanni Antonio Cutigni, San Mateo, CA (US); Maciej Mizerski, Kelowna (CA)

(73) Assignee: Roblox Corporation, San Mateo, CA (US)

(21) Appl. No.: 18/802,655

(22) Filed: Aug. 13, 2024

Related U.S. Application Data
(60) Provisional application No. 63/532,617, filed on Aug. 14, 2023.

(51) Int. Cl. G06T 13/40; G06T 17/20; G06T 19/00

(52) U.S. Cl. CPC G06T 13/40; G06T 17/20; G06T 19/006

(57) ABSTRACT

Implementations relate to methods, systems, and computer-readable media to render hair and hair-like features on user devices. In some implementations, the method includes receiving, at a user device that participates in a virtual experience, a hair model for a 3D object, wherein the hair model includes a plurality of curves, hair geometry metadata associated with one or more curves of the plurality of curves, and hair simulation metadata, generating, at the user device, hair geometry for the 3D object based on the hair model, the hair geometry metadata, and a type of the user device, simulating, at the user device, hair for the 3D object based on the hair geometry, the hair simulation metadata, and one or more physics parameters of the virtual experience, and rendering the 3D object with the simulated hair on the user device.

### CROSS-REFERENCE TO RELATED APPLICATIONS

This application claims priority to U.S. Provisional Application No. 63/532,617, entitled “HAIR DESIGN AND RENDERING IN VIRTUAL ENVIRONMENTS,” filed on Aug. 14, 2023, the content of which is incorporated herein in its entirety.

### TECHNICAL FIELD

Embodiments relate generally to computer-based virtual experiences and computer graphics, and more particularly, to methods, systems, and computer readable media for design, simulation, and rendering of hair and hair-like features on computing devices.

### BACKGROUND

Some online virtual experience platforms allow users to connect with each other, interact with each other (e.g., within a virtual experience), create virtual experiences, and share information with each other via the Internet. Users of online virtual experience platforms may participate in multiplayer environments (e.g., in virtual three-dimensional environments), design custom environments, design characters, three-dimensional (3D) objects, and avatars, decorate avatars, and exchange virtual items/objects with other users.

Hair and hair-like features associated with 3D objects are commonly utilized within virtual experience platforms. Accurate and realistic depiction of hair can be an important part of user self-expression and identity and can be a critical part of how users personalize their avatars. Additionally, hair-like features such as fur, grass, etc., are also utilized in virtual experiences on the virtual platform.

Rendering hair accurately poses several challenges, especially hair that is designed to be simulated and rendered on user devices at real time rates, e.g., at rates of 30 or 60 frames per second. Technical challenges include challenges in multiple operations leading up to the actual rendering of the hair, e.g., generation of hair geometry, simulation (physics) of hair, as well as the rendering of the hair on display devices.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform a method that includes receiving, at a user device that participates in a virtual experience, a hair model for a three-dimensional (3D) object, wherein the hair model includes a plurality of curves, hair geometry metadata associated with one or more curves of the plurality of curves, and hair simulation metadata, generating, at the user device, hair geometry for the 3D object based on the hair model, the hair geometry metadata, and a type of the user device, simulating, at the user device, hair for the 3D object based on the hair geometry, the hair simulation metadata, and one or more physics parameters of the virtual experience, and rendering the 3D object with the simulated hair on the user device.

In some implementations, the method may further include determining that the user device is of a first type, and in response to determining that the user device is of the first type, generating the hair geometry may include generating a geometry shell that encompasses the plurality of curves.

In some implementations, the method may further include determining that the user device is of a second type, and in response to determining that the user device is a device of the second type, generating the hair geometry may include generating a plurality of hair cards, where each hair card corresponds to a respective curve of the plurality of curves by extruding, along the respective curve, one of: a line segment and a polygon strip. In some implementations, the extruding may include extruding along the respective curve based on the hair geometry metadata associated with the curve to create one or more of a hair card, a tube, or a curl.

In some implementations, the method may further include determining that the user device is of a third type, and in response to determining that the user device is a device of the third type, generating the hair geometry may include generating one or more triangle strips based on the plurality of curves. In some implementations, creating a layer of hair cards may include generating hair cards that include hair with a sparse alpha texture.

In some implementations, generating the hair geometry may include generating one or more additional curves by interpolating between one or more pairs of curves in the plurality of curves. In some implementations, each curve of the plurality of curves is attached to a mesh face of a scalp mesh that can be fitted to the 3D object.

In some implementations, the method may further include determining a device type, and selecting, based on the device type, a generation technique to generate the hair geometry, wherein the generation technique is one of: generating a geometry shell that encompasses the plurality of curves, generating a plurality of hair cards, wherein each hair card corresponds to a respective curve of the plurality of curves, or generating one or more polygonal strips based on the plurality of curves.

In some implementations, the device type is of a first type, and the simulating the hair for the 3D object may include performing a vertex simulation based on the hair geometry. In some implementations, the device type is of a second type, and the simulating the hair for the 3D object may include performing a mesh simulation based on the hair geometry. In some implementations, the device type is of a third type, and in response to determining that the user device is a device of the third type, generating the hair geometry may include generating one or more triangle strips based on the plurality of curves.

In some implementations, the method may further include determining a computational load on the user device, and selecting the generation technique is further based on the computational load.

In some implementations, the method may further include receiving, during the virtual experience, an indication of a change in the computational load, and the method may further include re-generating the hair geometry based on the change in the computational load.

In some implementations, the method may further include procedurally generating a UV map corresponding to the generated hair geometry, wherein the UV map includes texture information associated with one or more points on a surface of the generated hair geometry.

One general aspect includes a non-transitory computer-readable medium with instructions stored thereon that when executed, performs operations that include receiving, at a user device that participates in a virtual experience, a hair model for a three-dimensional (3D) object, wherein the hair model includes a plurality of curves, hair geometry metadata associated with one or more curves of the plurality of curves, and hair simulation metadata, generating, at the user device, hair geometry for the 3D object based on the hair model, the hair geometry metadata, and a type of the user device, simulating, at the user device, hair for the 3D object based on the hair geometry, the hair simulation metadata, and one or more physics parameters of the virtual experience, and rendering the 3D object with the simulated hair on the user device.

Implementations may include the non-transitory computer-readable medium where the operations further include determining that the user device is of a first type, and in response to determining that the user device is of the first type, generating the hair geometry may include generating a geometry shell that encompasses the plurality of curves.

In some implementations, the operations may further include determining that the user device is of a second type, and in response to determining that the user device is a device of the second type, generating the hair geometry may include generating a plurality of hair cards, where each hair card corresponds to a respective curve of the plurality of curves by extruding, along the respective curve, one of: a line segment and a polygon strip. In some implementations, the extruding may include extruding along the respective curve based on the hair geometry metadata associated with the curve to create one or more of a hair card, a tube, or a curl.

In some implementations, the operations may further include determining that the user device is of a third type, and in response to determining that the user device is a device of the third type, generating the hair geometry may include generating one or more triangle strips based on the plurality of curves. In some implementations, creating a layer of hair cards may include generating hair cards that include hair with a sparse alpha texture.

In some implementations, generating the hair geometry may include generating one or more additional curves by interpolating between one or more pairs of curves in the plurality of curves. In some implementations, each curve of the plurality of curves is attached to a mesh face of a scalp mesh that can be fitted to the 3D object.

In some implementations, the operations may further include determining a device type, and selecting, based on the device type, a generation technique to generate the hair geometry, wherein the generation technique is one of: generating a geometry shell that encompasses the plurality of curves, generating a plurality of hair cards, wherein each hair card corresponds to a respective curve of the plurality of curves, or generating one or more polygonal strips based on the plurality of curves.

In some implementations, the device type is of a first type, and the simulating the hair for the 3D object may include performing a vertex simulation based on the hair geometry.

In some implementations, the device type is of a second type, and the simulating the hair for the 3D object may include performing a mesh simulation based on the hair geometry.

In some implementations, the operations may further include determining a computational load on the user device, and selecting the generation technique is further based on the computational load.

In some implementations, the operations may further include receiving, during the virtual experience, an indication of a change in the computational load, and the method may further include re-generating the hair geometry based on the change in the computational load.

In some implementations, the operations may further include procedurally generating a UV map corresponding to the generated hair geometry, wherein the UV map includes texture information associated with one or more points on a surface of the generated hair geometry.

One general aspect includes a system that includes a memory with instructions stored thereon; and a processing device coupled to the memory, the processing device configured to access the memory and execute the instructions, where the execution of the instructions cause the processing device to perform operations that may include receiving, at a user device that participates in a virtual experience, a hair model for a three-dimensional (3D) object, wherein the hair model includes a plurality of curves, hair geometry metadata associated with one or more curves of the plurality of curves, and hair simulation metadata, generating, at the user device, hair geometry for the 3D object based on the hair model, the hair geometry metadata, and a type of the user device, simulating, at the user device, hair for the 3D object based on the hair geometry, the hair simulation metadata, and one or more physics parameters of the virtual experience, and rendering the 3D object with the simulated hair on the user device.

Implementations may include the system where the operations may further include determining that the user device is of a second type, and in response to determining that the user device is a device of the second type, generating the hair geometry may include generating a plurality of hair cards, where each hair card corresponds to a respective curve of the plurality of curves by extruding, along the respective curve, one of: a line segment and a polygon strip. In some implementations, the extruding may include extruding along the respective curve based on the hair geometry metadata associated with the curve to create one or more of a hair card, a tube, or a curl.

### BRIEF DESCRIPTION OF THE DRAWINGS

FIG. 1 is a diagram of an example environment in which hair and hair-like features are designed, created, and rendered on a computing device, in accordance with some implementations.

FIG. 2 depicts examples of rendered hair and hair-like features (objects) in a virtual environment, in accordance with some implementations.

FIG. 3 depicts an example listing in a virtual marketplace for a hair object, in accordance with some implementations.

FIG. 4A depicts an example of a hair model that includes a set of specified curves and associated metadata, in accordance with some implementations.

FIG. 4B depicts example differentiation of virtual hair into clumps, in accordance with some implementations.

FIG. 5 illustrates an example method to graphically render virtual hair on a user device, in accordance with some implementations.

FIG. 6 depicts examples of hair features generated based on user specified curves, in accordance with some implementations.

FIG. 7 depicts an example hair editor tool for the design of virtual hair and hair-like features, in accordance with some implementations.

FIG. 8 illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some embodiments”, “an embodiment”, “an example embodiment”, etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be effected in connection with other embodiments whether or not explicitly described.

Online virtual experience platforms (also referred to as “user-generated content platforms” or “user-generated content systems”) offer a variety of ways for users to interact with one another. For example, users of an online virtual experience platform may work together towards a common goal, share various virtual experience items, send electronic messages to one another, and so forth. Users of an online virtual experience platform may join virtual experience(s), e.g., games or other experiences as virtual characters, playing specific roles. For example, a virtual character may be part of a team or multiplayer environment wherein each character is assigned a certain role and has associated parameters, e.g., clothing, armor, weaponry, skills, etc. that correspond to the role. In another example, a virtual character may be joined by computer-generated characters, e.g., when a single player is part of a game.

A virtual experience platform may enable users (developers) of the platform to create objects, new games, and/or characters. For example, users of the online gaming platform may be enabled to create, design, and/or customize new characters (avatars), new animation packages, new three-dimensional objects, etc. and make them available to other users.

Objects, e.g., virtual objects, may be traded, bartered, or bought and sold in online marketplaces for virtual and/or real currency. A virtual object may be offered within a virtual experience or virtual environment in any quantity, such that there may be a single instance (“unique object”), very few instances (“rare object”), a limited number of instances (“limited quantity”), or unlimited number of instances (“common object”) of a particular object within the virtual experience or environment.

On some virtual platforms, developer users may upload three-dimensional (3D) object models, e.g., meshes and/or textures of 3D objects, for use in a virtual experience and for trade, barter, or sale on an online marketplace. The models may be utilized and/or modified by other users. The model can include 3D meshes that represent the geometry of the object and include vertices, and define edges, and faces. The model may additionally include textures that define the object surface.

Hair and hair-like features associated with 3D objects are commonly utilized within virtual platforms. Accurate and realistic depiction of hair can be an important part of user self-expression and identity and can be a critical part of how users personalize their avatars. Additionally, hair-like features such as fur, grass, etc., are also utilized in virtual experiences on the virtual platform.

Rendering hair accurately poses several challenges, especially hair that is designed to be simulated and rendered on user devices at real time rates, e.g., at rates of 30 or 60 frames per second. Technical challenges include challenges in multiple operations leading up to the actual rendering of the hair, e.g., generation of hair geometry, simulation (physics) of hair, as well as the rendering of the hair on display devices.

For example, a typical head of human hair may include over 100,000 individual hair strands. Representing each strand of hair in hair geometry is computationally not feasible, thereby necessitating constructing the hair geometry based on approximations. The approximations may vary widely based on a type of user device (platform). For example, greater approximations may be made on user devices with limited computational resources, e.g., low-end mobile phones, whereas fewer approximations may be made on user devices with higher computational resources, e.g., high-end personal computers (PC).

The accurate rendering of hair also needs accurate simulation of the hair, e.g., physically accurate simulation of hair. Hair simulation is commonly performed by utilizing custom physics/simulation programs (code). In addition to the mathematical (and computational) complexity of the programs, the programs can also be challenging to run efficiently at 30 or 60 frames per second along with other 3D objects being simulated and rendered in the virtual environment. Implementations of hair simulation techniques may also have to be adjusted to different types of user devices in order to meet real-time performance requirements.

Additionally, a type of hair simulation technique being utilized may also have to be compatible with the type of hair geometry being utilized for a particular type of user device. For example, simulation of hair geometry on a user device where the hair is represented as strands may have to utilize a different hair simulation approach from simulation of hair geometry on a user device where the hair is represented as a volume.

Rendering of hair on a user device based on simulated hair also presents technical challenges. In particular, rendering of accurately shaded hair to mimic effects of sheen, lighting, etc., can be computationally intensive. Representing the distinctive sheen of hair requires custom rendering code, which may not run efficiently on all user devices.

An objective of a virtual experience platform owner or administrator is realistic onscreen depiction of hair and hair-like features. An additional objective of the virtual experience platform owner or administrator is to provide tools to creators of original content that can enable them to design and generate 3D objects that include hair and hair-like features.

A technical problem for operators and/or administrators of virtual experience platforms is the provision of automatic, accurate, scalable, cost-effective, and reliable tools for creation (generation) of hair geometry as well as for hair simulation and rendering. An additional problem for operators and/or administrators of virtual experience platforms is to provide superior user experience for multiple types of user devices that are supported on the platform.

Techniques described herein may be utilized to provide a scalable and adaptive technical solution to the creation (generation) of hair geometry as well as for hair simulation and rendering. Various implementations described herein address the above-described drawbacks by providing techniques for an implementation-independent schema based on real-world concepts that encompasses generation of hair geometry, simulation of hair, and rendering of hair.

In some implementations, tools are provided to enable creators to author (create) hair that is represented (and stored) as a set of curves along with associated metadata that is utilized to codify creator intent regarding the hairstyle.

At run-time, e.g., during a virtual experience session, the hair geometry is procedurally generated based on the set of curves and associated metadata. Based on the procedurally generated hair geometry, hair is simulated and rendered locally at a user device. The density and style of geometry generation is tuned to the current platform. Based on the curves and metadata associated with a defined hairstyle, hair geometry can be generated and new curves can be automatically generated via interpolation of the pre-defined curves to create new hair strands. This enables simplification of hair creation and also enables automatic updating of the geometry generation, simulation, and rendering based on improvements to techniques. Additional metadata attributes can be added at a time subsequent to a time of hairstyle creation to provide additional customization.

The virtual platform can also enable users to recolor the hair during their participation in a virtual experience, thereby enabling creators and players to customize hair color.

Utilization of procedural generation of the hair geometry enables automation of the tedious parts of hair creation. This also enables consistency of user experience across multiple types of user devices, and leads to a higher average quality of hair rendering and fewer edge cases.

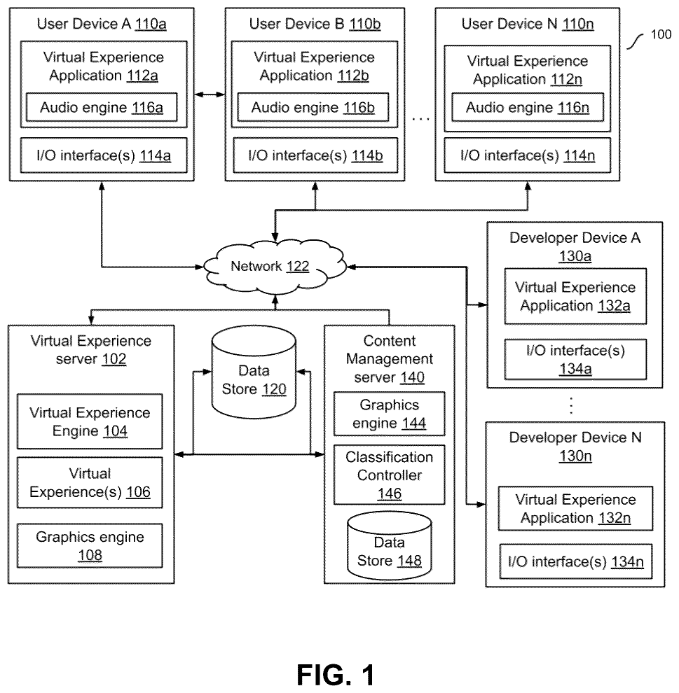

FIG. 1 is a diagram of an example environment in which hair and hair-like features are designed, created, and rendered on a computing device, in accordance with some implementations. FIG. 1 and other figures use like reference numerals to identify like elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture 100 (also referred to as “system” herein) includes online virtual experience server 102, data store 120, user devices 110a, 110b, and 110n (generally referred to as “user device(s) 110” herein), and developer devices 130a and 130n (generally referred to as “developer device(s) 130” herein), virtual experience server 102, content management server 140, data store 120, user devices 110, and developer devices 130 are coupled via network 122. In some implementations, user devices(s) 110 and developer device(s) 130 may refer to the same or same type of device.

Online virtual experience server 102 can include a virtual experience engine 104, one or more virtual experience(s) 106, and graphics engine 108. A user device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc. The input/output devices can also include accessory devices that are connected to the user device by means of a cable (wired) or that are wirelessly connected.

Content management server 140 can include a graphics engine 144, and a classification controller 146. In some implementations, the content management server may include a plurality of servers. In some implementations, the plurality of servers may be arranged in a hierarchy, e.g., based on respective prioritization values assigned to content sources.

Graphics engine 144 may be utilized for the rendering of one or more objects, e.g., 3D objects associated with the virtual environment. Classification controller 146 may be utilized to classify assets such as 3D objects and for the detection of inauthentic digital assets, etc. Data store 148 may be utilized to store a search index, model information, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, a cloud storage system, or another type of component or device capable of storing data. The data store 120 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, a distributed computing system, a cloud computing system, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on user devices 110.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., synchronous and/or asynchronous text-based communication). In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be an online gaming server. For example, the virtual experience server may provide single-player or multiplayer games to a community of users that may access or interact with games using user devices 110 via network 122. In some implementations, games (also referred to as “video game,” “online game,” or “virtual game” herein) may be two-dimensional (2D) games, three-dimensional (3D) games (e.g., 3D user-generated games), virtual reality (VR) games, or augmented reality (AR) games, for example. In some implementations, users may participate in gameplay with other users. In some implementations, a game may be played in real-time with other users of the game.

In some implementations, gameplay may refer to the interaction of one or more players using user devices (e.g., 110) within a game (e.g., game that is part of virtual experience 106) or the presentation of the interaction on a display or other output device (e.g., 114) of a user device 110.

In some implementations, a virtual experience 106 can include an electronic file that can be executed or loaded using software, firmware or hardware configured to present the game content (e.g., digital media item) to an entity. In some implementations, a virtual experience application 112 may be executed and a virtual experience 106 executed in connection with a virtual experience engine 104. In some implementations, a virtual experience (e.g., a game) 106 may have a common set of rules or common goal, and the environment of a virtual experience 106 shares the common set of rules or common goal. In some implementations, different games may have different rules or goals from one another.

In some implementations, virtual experience(s) may have one or more environments (also referred to as “gaming environments” or “virtual environments” herein) where multiple environments may be linked. An example of an environment may be a three-dimensional (3D) environment. The one or more environments of a virtual experience application 106 may be collectively referred to a “world” or “gaming world” or “virtual world” or “universe” herein. An example of a world may be a 3D world of a game. For example, a user may build a virtual environment that is linked to another virtual environment created by another user. A character of the virtual game may cross the virtual border to enter the adjacent virtual environment.

It may be noted that 3D environments or 3D worlds use graphics that use a three-dimensional representation of geometric data representative of game content (or at least present game content to appear as 3D content whether or not 3D representation of geometric data is used). 2D environments or 2D worlds use graphics that use two-dimensional representation of geometric data representative of game content.

In some implementations, the online virtual experience server 102 can host one or more virtual experiences 106 and can permit users to interact with the virtual experiences 106 using a virtual experience application 112 of user devices 110. Users of the online virtual experience server 102 may play, create, interact with, or build virtual experiences 106, communicate with other users, and/or create and build objects (e.g., also referred to as “item(s)” or “game objects” or “virtual game item(s)” herein) of virtual experiences 106. For example, in generating user-generated virtual items, users may create characters, decoration for the characters, one or more virtual environments for an interactive game, or build structures used in a game. In some implementations, users may buy, sell, or trade virtual game objects, such as in-platform currency (e.g., virtual currency), with other users of the online virtual experience server 102. In some implementations, online virtual experience server 102 may transmit game content to virtual experience applications (e.g., 112). In some implementations, game content (also referred to as “content” herein) may refer to any data or software instructions (e.g., game objects, game, user information, video, images, commands, media item, etc.) associated with online virtual experience server 102 or virtual experience applications. In some implementations, game objects (e.g., also referred to as “item(s)” or “objects” or “virtual objects” or “virtual game item(s)” herein) may refer to objects that are used, created, shared or otherwise depicted in virtual experiences 106 of the online virtual experience server 102 or virtual experience applications 112 of the user devices 110. For example, game objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration, rather than limitation. In some implementations, online virtual experience server 102 may host one or more media items that can include communication messages from one user to one or more other users. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual application 106 may be associated with a particular user or a particular group of users (e.g., a private game), or made widely available to users with access to the online virtual experience server 102 (e.g., a public game). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or user devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the game (e.g., rendering commands, collision commands, physics commands, etc.) In some implementations, virtual experience applications 112 of user devices 110, may work independently, in collaboration with virtual experience engine 104 of online virtual experience server 102, or a combination of both.

In some implementations, both the online virtual experience server 102 and user devices 110 may execute a virtual experience engine and a virtual experience application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of user device 110. In some implementations, each virtual application 106 may have a different ratio between the virtual experience engine functions that are performed on the online virtual experience server 102 and the virtual experience engine functions that are performed on the user devices 110. For example, the virtual experience engine 104 of the online virtual experience server 102 may be used to generate physics commands in cases where there is a collision between at least two virtual application objects, while the additional virtual experience engine functionality (e.g., generate rendering commands) may be offloaded to the user device 110. In some implementations, the ratio of virtual experience engine functions performed on the online virtual experience server 102 and user device 110 may be changed (e.g., dynamically) based on gameplay conditions. For example, if the number of users participating in gameplay of a particular virtual application 106 exceeds a threshold number, the online virtual experience server 102 may perform one or more virtual experience engine functions that were previously performed by the user devices 110.

For example, users may be playing a virtual application 106 on user devices 110, and may send control instructions (e.g., user inputs, such as right, left, up, down, user election, or character position and velocity information, etc.) to the online virtual experience server 102. Subsequent to receiving control instructions from the user devices 110, the online virtual experience server 102 may send gameplay instructions (e.g., position and velocity information of the characters participating in the group gameplay or commands, such as rendering commands, collision commands, etc.) to the user devices 110 based on control instructions. For instance, the online virtual experience server 102 may perform one or more logical operations (e.g., using virtual experience engine 104) on the control instructions to generate gameplay instruction(s) for the user devices 110. In other instances, online virtual experience server 102 may pass one or more or the control instructions from one user device 110 to other user devices (e.g., from user device 110a to user device 110b) participating in the virtual application 106. The user devices 110 may use the gameplay instructions and render the gameplay for presentation on the displays of user devices 110.

In some implementations, the control instructions may refer to instructions that are indicative of in-game actions of a user's character. For example, control instructions may include user input to control the in-game action, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a user device 110 to another user device (e.g., from user device 110b to user device 110n), where the other user device generates gameplay instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, gameplay instructions may refer to instructions that allow a user device 110 to render gameplay of a game, such as a multiplayer game. The gameplay instructions may include one or more of user input (e.g., control instructions), character position and velocity information, or commands (e.g., physics commands, rendering commands, collision commands, etc.).

In some implementations, the online virtual experience server 102 may store characters created by users in the data store 120. In some implementations, the online virtual experience server 102 maintains a character catalog and game catalog that may be presented to users. In some implementations, the game catalog includes images of virtual experiences stored on the online virtual experience server 102. In addition, a user may select a character (e.g., a character created by the user or other user) from the character catalog to participate in the chosen game. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the virtual experience platform may support three-dimensional (3D) objects that are represented by a 3D model and includes a surface representation used to draw the character or object (also known as a skin or mesh) and a hierarchical set of interconnected bones (also known as a skeleton or rig). The rig may be utilized to animate the object and to simulate the motion of the object. The 3D model may be represented as a data structure, and one or more parameters of the data structure may be modified to change various properties of the character, e.g., dimensions (height, width, girth, etc.); shape; movement style; number/type of parts; proportion, etc.

In some implementations, the 3D model may include a 3D mesh. The 3D mesh may define a three-dimensional structure of an unauthenticated virtual 3D object. In some implementations, the 3D mesh may also define one or more surfaces of the 3D object. In some implementations, the 3D object may be a virtual avatar, e.g., a virtual character such as a humanoid character, an animal-character, a robot-character, etc.

In some implementations, the mesh may be received (imported) in a FBX file format. The mesh file includes data that provides dimensional data about polygons that comprise the virtual 3D object and UV map data that describes how to attach portions of texture to various polygons that comprise the 3D object. In some implementations, the 3D object may correspond to an accessory, e.g., a hat, a weapon, a piece of clothing, etc. worn by a virtual avatar or otherwise depicted with reference to a virtual avatar.

In some implementations, a platform may enable users to submit (upload) candidate 3D objects for utilization on the platform. A virtual experience development environment (developer tool) may be provided by the platform, in accordance with some implementations. The virtual experience development environment may provide a user interface that enables a developer user to design and/or create virtual experiences, e.g., games. The virtual experience development environment may be a client-based tool (e.g., downloaded and installed on a client device, and operated from the client device), a server-based tool (e.g., installed and executed at a server that is remote from the client device, and accessed and operated by the client device), or a combination of both client-based and service-based elements.

The virtual experience development environment may be operated by a developer of a virtual experience, e.g., a game developer or any other person who seeks to create a virtual experience that may be published by an online virtual experience platform and utilized by others. The user interface of the virtual experience development environment may be rendered on a display screen of a client device, e.g., such as a developer device 130 described with reference to FIG. 1, so as to enable the creator/developer to interact with the development environment using actions such as typing, highlighting, selecting, drag and drop, clicking, and so forth via a mouse, keyboard, or other input device configured to communicate with the user interface. The user interface may include a menu bar, a tool bar, a workspace pane, and a plurality of secondary panes. Depending on the particular implementation, the user interface may include alternative or additional elements, arrangements, operational features, etc. of the virtual experience development environment than what is shown and described herein.

A developer user (creator) may utilize the virtual experience development environment to create virtual experiences. As part of the development process, the developer/creator may upload various types of digital content such as object files (meshes), image files, audio files, short videos, etc., to enhance the virtual experience.

In implementations where the candidate (unauthenticated) 3D object is an accessory, data indicative of use of the object in a virtual experience may also be received. For example, a “shoe” object may include annotations indicating that the object can be depicted as being worn on the feet of a virtual humanoid character, while a “shirt” object may include annotations that it may be depicted as being worn on the torso of a virtual humanoid character.

In some implementations, the 3D model may further include texture information associated with the 3D object. For example, texture information may indicate color and/or pattern of an outer surface of the 3D object. The texture information may enable varying degrees of transparency, reflectiveness, degrees of diffusiveness, material properties, and refractory behavior of the textures and meshes associated with the 3D object. Examples of textures include plastic, cloth, grass, a pane of light blue glass, ice, water, concrete, brick, carpet, wood, etc.

In some implementations, the user device(s) 110 may each include computing devices such as personal computers (PCs), mobile devices (e.g., laptops, mobile phones, smart phones, tablet computers, or netbook computers), network-connected televisions, gaming consoles, etc. In some implementations, a user device 110 may also be referred to as a “client device.” In some implementations, one or more user devices 110 may connect to the online virtual experience server 102 at any given moment. It may be noted that the number of user devices 110 is provided as illustration. In some implementations, any number of user devices 110 may be used.

In some implementations, each user device 110 may include an instance of the virtual experience application 112, respectively. In one implementation, the virtual experience application 112 may permit users to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a gaming program) that is installed and executes local to user device 110 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

In some implementations, the virtual experience application may include an audio engine 116 that is installed on the user device, and which enables the playback of sounds on the user device. In some implementations, audio engine 116 may act cooperatively with audio engine 144 that is installed on the sound server.

According to aspects of the disclosure, the virtual experience application may be an online virtual experience server application for users to build, create, edit, upload content to the online virtual experience server 102 as well as interact with online virtual experience server 102 (e.g., participate in virtual experiences 106 hosted by online virtual experience server 102). As such, the virtual experience application may be provided to the user device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual game hosted by online virtual experience server 102, or view or upload content, such as games, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a virtual experience program) that is installed and executes local to user device 130 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or play games hosted by online virtual experience server 102). As such, the virtual experience application may be provided to the user device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual applications 106 developed, hosted, or provided by a virtual experience application developer.

In some implementations, a user may login to online virtual experience server 102 via the virtual experience application. The user may access a user account by providing user account information (e.g., username and password) where the user account is associated with one or more characters available to participate in one or more virtual experience(s) 106 of online virtual experience server 102. In some implementations, with appropriate credentials, a virtual experience application developer may obtain access to virtual experience application objects, such as in-platform currency (e.g., virtual currency), avatars, special powers, accessories, that are owned by or associated with other users.

In general, functions described in one implementation as being performed by the online virtual experience server 102 can also be performed by the user device(s) 110, or a server, in other implementations if appropriate. In addition, the functionality attributed to a particular component can be performed by different or multiple components operating together. The online virtual experience server 102 can also be accessed as a service provided to other systems or devices through appropriate application programming interfaces (APIs), and thus is not limited to use in websites.

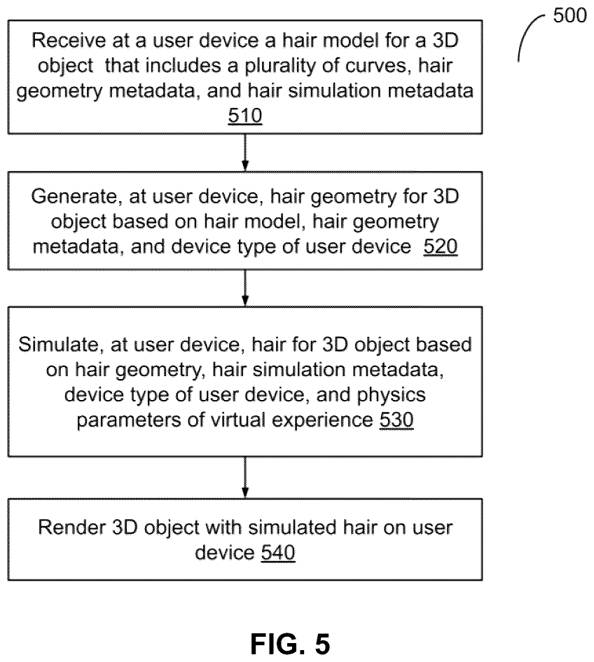

In some implementations, online virtual experience server 102 may include a graphics engine 108. In some implementations, the graphics engine 108 may be a system, application, or module that permits the online virtual experience server 102 to provide graphics and animation capability. In some implementations, the graphics engine 108, and/or content management server 140 may perform one or more of the operations described below in connection with the flow charts shown in FIG. 5.

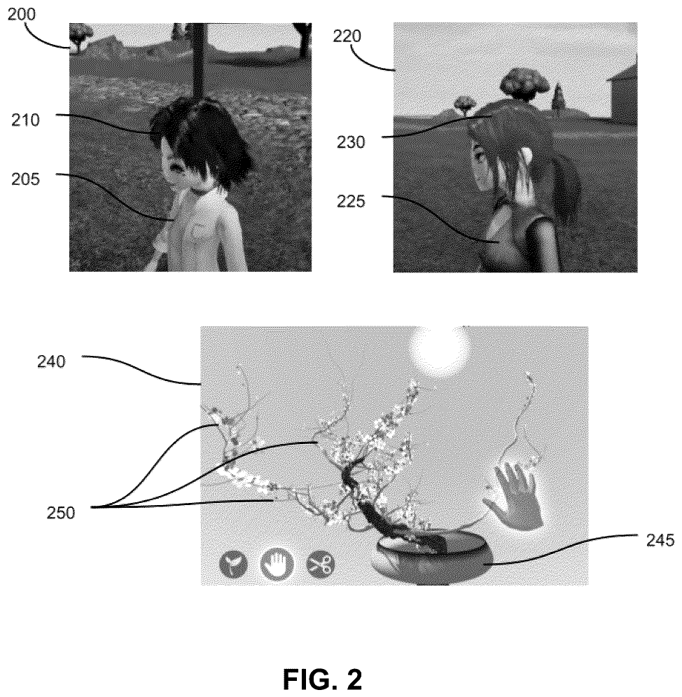

FIG. 2 depicts examples of rendered hair and hair-like features (objects) in a virtual environment, in accordance with some implementations. A first scene 200 from a virtual experience, a second scene 220 from another virtual experience, and a view 240 of a 3D object are depicted.

As illustrated in FIG. 2, the first scene 200 includes a virtual character/avatar 205 with associated hair 210.

The second scene 220 includes a virtual character/avatar 225 that has associated hair 230.

The view 240 depicts a 3D object 245, which is a bonsai object that includes hair-like branches 250.

As depicted in this illustrative example, rendered hair and hair-like features constitute an important visual component in virtual experiences. It is beneficial for a virtual environment platform to enable the creation and use of multiple types of hairstyle and hair-like features that can lead to a superior user experience.

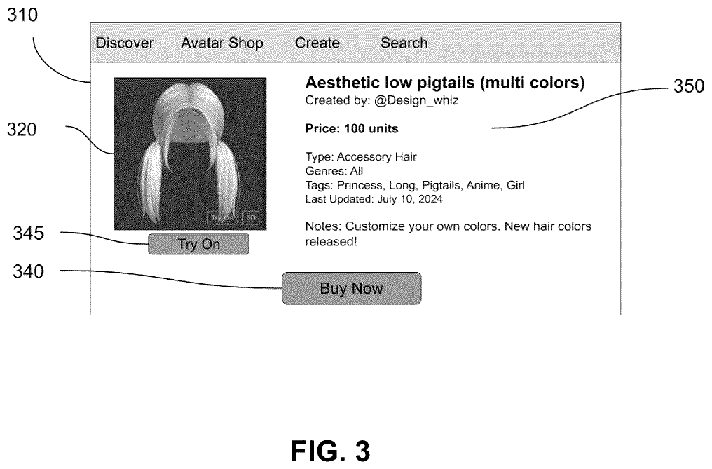

FIG. 3 depicts an example listing in a virtual marketplace for a hair object, in accordance with some implementations.

In some scenarios, a virtual experience platform may enable developer (creator) users to create 3D objects, e.g., hairstyles, that may be purchased by other users and subsequently be utilized by the users within virtual experiences. For example, a hairstyle may be purchased by a user and fitted to their avatar.

In this illustrative example, an example listing 310 for a hairstyle is depicted. The listing 310 includes an image 320 of the hairstyle and an associated description 350. Suitable controls may be provided within the listing to enable a user to try on 345 the hairstyle, as well as to purchase (340) the hairstyle.

A virtual experience platform may enable multiple listings of hairstyles, and other hair-like features for purchase and/or utilization by users of the platform.

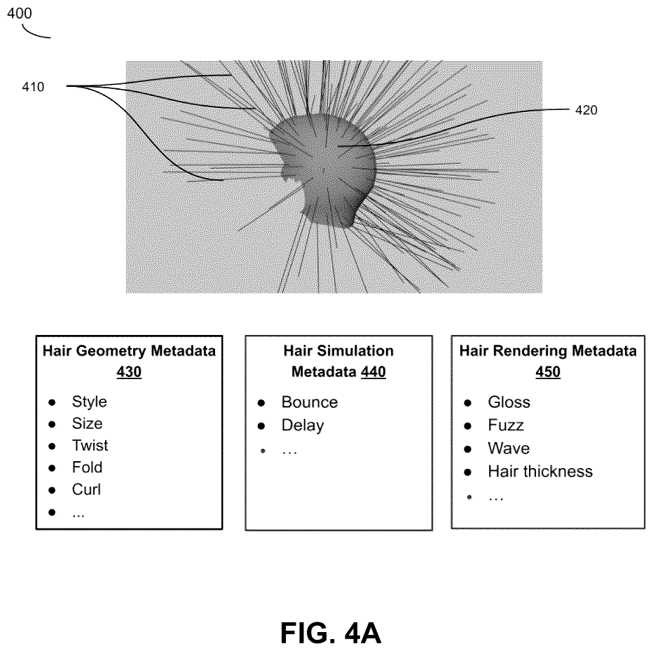

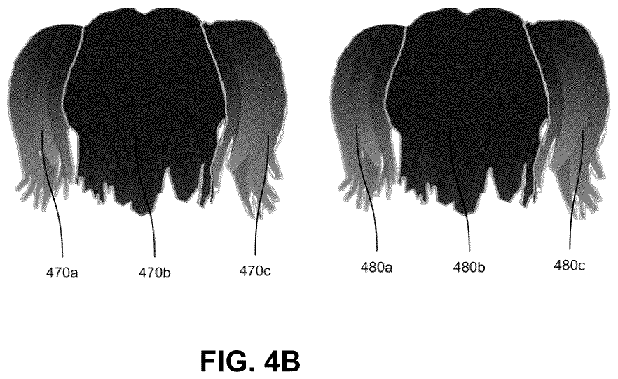

FIG. 4A depicts an example of a hair model that includes a set of specified curves and associated metadata, in accordance with some implementations.

Per techniques of this disclosure, hair and hair-like features are rendered based on an implementation independent design authored by a designer (creator or developer user). As depicted in FIG. 4A, the hair model 400 includes a set of curves 410 that are attached to a generalized scalp mesh 420.

The hair model 400 additionally includes metadata associated with the set of curves 410. The metadata may include metadata that applies to various operations utilized for the end-to-end hair rendering process, e.g., hair geometry metadata 430, hair simulation metadata 440, and hair rendering metadata 450.

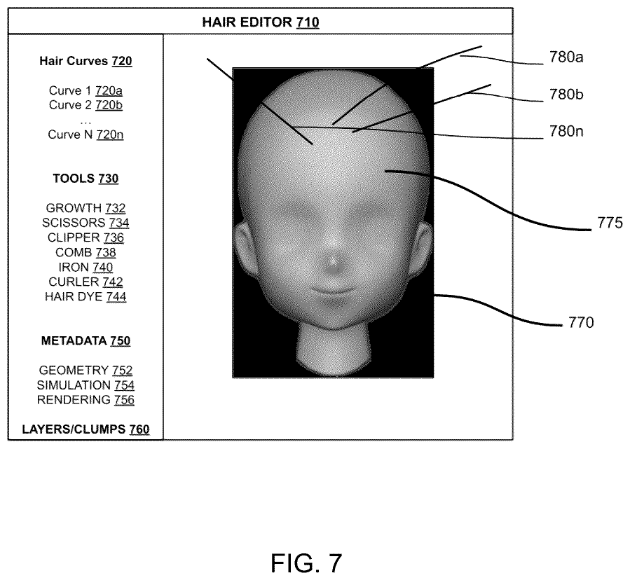

In some implementations, a hair editor tool (described later herein with reference to FIG. 7) may be provided to enable a user to specify details of the set of curves and the metadata. In some implementations, the hair editor tool may enable a developer user to specify the set of curves using one or more tools, e.g., by providing a mathematical expression that defines each curve, via a drag tool that enables a user to use a suitable pointer tool and a display screen to draw out each curve. In some scenarios, the tools may be combined, e.g., a set of simple curves may be specified mathematically, while another set of other curves may be drawn on a screen by the developer user.

The set of curves may include a variety of types of curves. Without limitation, the set of curves may include straight lines, splines, parabolas, arcs, etc. In some implementations, the curves may be defined explicitly, e.g., by specifying control points and tangents. In some other implementations, the curves may be defined implicitly, e.g., by specifying a mathematical function).

In some implementations, the set of curves may be derived from a volume, e.g., via a definition of curves inside a user-authored hair mesh. In some implementations, the set of curves may be generated automatically, e.g., by applying a machine learning (ML) technique.

For example, the hair geometry metadata 430 may include attributes such as style, size, twist, fold, curl, etc. In some implementations, the attributes may be associated with values specified by the developer user. In some other implementations, the attribute values may be selected by the user from a set of provided options, e.g., via a drop-down menu. The hair geometry metadata 430 may include a specification of values for attributes that are related to the hair geometry for the hairstyle (or hair-like feature).

The hair simulation metadata 440 may include a specification of values for attributes that are related to parameters utilized to simulate the hair or hair-like feature. For example, the hair simulation metadata 440 may include attributes such as bounce, delay, etc. The attributes included in simulation metadata 440 may subsequently be utilized during simulation of the hair, e.g., during application of a physics solver to the hair geometry, etc.

The hair rendering metadata 450 may include a specification of values for attributes that are related to parameters utilized to render (e.g., display on a screen of a user device) the hair or hair-like feature. For example, the hair simulation metadata 450 may include attributes such as gloss, fuzz, wave, hair thickness, etc., that may be utilized to suitably render the simulated hair on a user device.

FIG. 4B depicts example differentiation of virtual hair into clumps, in accordance with some implementations.

In addition to specifying the hair model 400 based on a set of curves and associated metadata, a developer user may additionally partition (differentiate) the hair into distinct regions. The hair may be differentiated for the purposes of simulation of the movement of the hair and/or for rendering the hair.

As depicted in FIG. 4B, the hair may be partitioned into color clumps 460 and movement clumps 465. In this illustrative example, color clumps include clumps 470a, 470b, and 470c. The developer user (creator of the hair design) and/or end-user (e.g., a player that has purchased the hair model for use with their avatar) may select specific colors for each clump. During a virtual experience session, the hair clumps are rendered on the user device based on the selected color.

Movement clumps 465 may be utilized to partition the hair into regions where a single set of physics parameters may be applied to each region during hair simulation. In this illustrative example, movement clumps include clumps 480a, 480b, and 480c. Different physics parameters may be applied to each clump 480a, 480b, and 480c during hair simulation. The clumps may be associated with particular movement related parameters such as bounciness, looseness, floppiness, etc. During simulation of the hair at the user device, suitable physics parameters that are matched to the movement related parameters are applied to the selected clumps.

FIG. 5 illustrates an example method to graphically render virtual hair on a user device, in accordance with some implementations.

In some implementations, method 500 can be implemented, for example, on gaming server 102 described with reference to FIG. 1. In some implementations, some or all portions of the method 500 can be implemented on one or more client devices 110 as shown in FIG. 1, on one or more developer devices 130, or on one or more server device(s) 102, and/or on a combination of developer device(s), server device(s) and client device(s). In described examples, the implementing system includes one or more digital processors or processing circuitry (“processors”), and one or more storage devices (e.g., a database 120 or other storage). In some implementations, different components of one or more servers and/or clients can perform different blocks or other parts of the method 500. In some examples, a first device is described as performing blocks of method 500. Some implementations can have one or more blocks of method 500 performed by one or more other devices (e.g., other client devices or server devices) that can send results or data to the first device.

In some implementations, the method 500, or portions of the method, can be initiated automatically by a system. In some implementations, the implementing system is a first device. For example, the method (or portions thereof) can be periodically performed, or performed based on one or more particular events or conditions, e.g., a change in a number of 3D objects in a virtual experience, a change in available computational processing power on a user device (client device), a predetermined time period having expired since the last performance of method 500, and/or one or more other conditions occurring which can be specified in settings read by the method.

Method 500 may begin at block 510. At block 510, a hair model (for example, hair model 400 described with reference to FIG. 4) for a 3D object is received (obtained) at a user device. For example, the hair model may be a mathematical model for hair associated with an avatar that participates in a virtual experience. Alternatively, the hair model may be a mathematical model for a hair-like feature such as grass, bonsai branches, etc. In some implementations, the hair model may include specification of a plurality of curves, hair geometry metadata associated with one or more curves of the plurality of curves, and hair simulation metadata. In some implementations, the hair model may additionally include hair rendering metadata.

In some implementations, the hair model may be obtained from a server, e.g., virtual experience server 102, at a time of commencement of participation of a user associated with the user device in a virtual experience. For example, if the user (player) is participating in an online game, the hair model may be obtained at the user device at a time when the player initially joined the game.

In some implementations, the hair model may be obtained at a predetermined frequency during a user's participation in a virtual experience. This may enable adjustments to the hair model, e.g., based on changes to the hair model made by a developer user (creator).

As described earlier with reference to FIG. 4A, each curve of the plurality of curves is attached to a mesh face of a scalp mesh 420. Block 510 may be followed by block 520.

At block 520, hair geometry for the 3D object is procedurally generated at the user device based on the hair model, the hair geometry metadata, and a type of the user device.

In some implementations, procedural generation of the hair geometry includes creation of the data algorithmically (as opposed to being authored by a human) at run-time and at the user device. In some implementations, the algorithms may be coupled with computer-generated randomness and processing power. In some implementations, the hair geometry is generated at a level of detail (LOD) based on a capability of the user device. The LOD refers to a degree of granularity in representing aspects of the hair. For example, certain hair features may be omitted from the hair geometry generated for certain types (device types) of user devices.

In user devices with limited processing power, low-resolution LODs may be utilized. In addition, rendering of hair and hair-like features for 3D objects proximate to the user (player) in the virtual experience may be prioritized. For other 3D objects, hair features with simple materials may be utilized, and in some scenarios, rendered statically, without real-time simulation of the hair.

In some implementations, the procedural generation (build) of LODs may be performed at the same time as the procedural generation of the hair geometry. An example scenario is the extrusion of a line segment along a curve to create a hair card. In this illustrative scenario, the line segment has N vertices, and the curve has M vertices, for a total of N times M (N×M) vertices. In this scenario, a reduced size LOD (e.g., for a user device with limited processing power) may be built by reducing the size of the line segment (e.g., by using 2 vertices instead of 4 vertices), and by omitting every other curve vertex. This would provide an LOD geometry with N/2 times M/2 vertices, which is 25% of the vertex count of the full-resolution hair card.

In some implementations, further reductions in vertex count may be realized by performing a holistic analysis of the set of curves. For example, instead of building one hair card per curve, the endpoints of all of the curves may be obtained to create a point cloud, which may then be fitted with a mesh. This results in a LOD mesh with a single (1) vertex per hair curve. Such reductions in LOD may be advantageous for very low-end mobile devices where minimization of hair geometry is needed, as well as for high end user devices that may include many avatars with hair onscreen.

In some implementations, a distance of 3D objects from a camera view on a user device may be considered to determine a suitable LOD. For example, for 3D objects that meet a threshold distance, it may be determined that the associated hair will be represented with a relatively small number of pixels, and that detailed hair geometry is not needed for the 3D objects.

In some implementations, a device type of the user device is determined. Based on the device type of the user device, a suitable geometry generation technique is applied to generate the hair geometry based on the received hair model and hair geometry metadata included in the hair model. The generation technique is selected based on the capabilities of the user device such that the technique is compatible with resources available on the user device, e.g., computational power, memory, etc.

In some implementations, the device type is based on information received about the capabilities of the user device. In some implementations, a database of devices and their capabilities and/or device type may be maintained on the virtual experience platform. In some implementations, an identifier associated with the user device, e.g., model type, brand, etc., may be utilized to determine the device type of the user device. In some other implementations, test computational operations may be performed on the user device to assess (ascertain) the capabilities and/or device type of the user device.

In some implementations, the generation technique for a particular device type may include generating a geometry shell that encompasses the plurality of curves.

In some implementations, the geometry shell is a skin that is applied to encompass the plurality of curves specified in the hair model. The shell may be positioned to be offset by a predetermined distance from the outermost point of each curve of the plurality of curves. In some implementations, the generation technique may include generating a hair volume by extruding an N-gon or another suitable curve, e.g., triangle, cube, circle, etc., along the hair curve.

In some implementations, the generation technique for another device type may include generating a plurality of hair cards. In such implementations, each hair card of the plurality of hair cards may correspond to a respective curve of the plurality of curves. The hair cards may be generated by extruding, along the respective curve, a line segment or a polygon. In some implementations, where additional quality is needed and is supported by device capability, a second layer of hair cards may be generated. The second layer may be offsite slightly along the normal to the hair curve(s) and may utilize a sparse hair texture that may include portions that are rendered using an alpha channel (alpha blend). The alpha channel enables localized texture invisibility for portions by utilizing an image to mask out areas of the surface, thereby letting the background texture to show through. The second layer of hair cards provides rendered hair with additional depth and texture. In some implementations, a third layer of flyaway hair cards with a very sparse alpha texture may be generated for added quality.

In some implementations, generation of the hair cards includes converting the user-specified curves associated with the hair or hair-like feature (e.g., fur, grass, etc.) into polygon cards, while maintaining the style and shape specified by the hair geometry metadata elements.

In some implementations, selection of a suitable shape for extrusion of a curve (e.g., line, polygon, etc.) is based on the type of hair and/or artistic intent specified via the metadata. For example, for a bob hairstyle, a line extruded along a curve may be utilized to create a flat (or flat-like) hair card, since a flat surface provides the look and feel of smooth hair. However, for a hairstyle such as a dreadlock, a circle may be extruded along the curve to form a tube, since tubes can offer a superior representation for a dreadlock. Similarly, a hairstyle such as a cornrow may be implemented with a half-circle extruded on a curve along with utilization of a custom texture to provide the cornrow appearance.

In some implementations, proximate curves may be grouped into clusters and polygon cards may be generated for each cluster, with the width and orientation of each cluster matching the original curves included in the respective clusters.

In some implementations, the generation technique for a device type may include generating one or more polygonal (e.g., triangular) strips based on the plurality of curves. This may provide the highest level of accuracy, but with high computational complexity. By rendering triangle strips, the hair geometry most closely approximate hair strands. Curves are interpolated between authored hair curves and strips are rendered along each interpolated curve, such that each triangle strip would approximate a small number of hair strands. In some implementations, on user devices with advanced CPU/GPUs, each of the 100,000 plus hairs on an actual human head would be represented by an individual triangle strip.

For example, a first type of user device may be user devices with relatively low capabilities, e.g., mobile phones with limited resources. In response to determining that the user device is of the first type, generating the hair geometry may include generating a geometry shell that encompasses the plurality of curves.

In some implementations, the geometry shell is generated along with corresponding UV maps that may be utilized to render a suitable texture for the hair. The geometry shell is generated such that it encompasses the user-defined curves that represent the hairstyle. Utilization of a geometry shell may provide a basic representation of the hair with high computational efficiency.

In some implementations, a second type of user device may include devices with capabilities greater than devices of the first type. For example, the second type of user devices may include mid-range mobile phones that may include increased computational resources, e.g., processing power, memory, availability of advanced processors, etc., when compared to user devices of the first type.

In response to determining that the user device is of the second type, generating the hair geometry may include generating a plurality of hair cards, wherein each hair card corresponds to a respective curve of the plurality of curves included in the hair model.

In some implementations, the hair cards may be generated by extruding a line segment or polygon along the curves (user-defined) included with the hair model. The authored metadata is used to define the width of the hair card (including any specified tapering), orientation (including any specified twists along the curve). Noise is added during the procedural generation to create variations between the hair cards). In some implementations, the width and orientation of each hair card are defined to minimize any visual gaps between adjacent hair cards.

The hair cards may be generated by extruding a line segment along the respective curve or by extruding a polygon along the respective curve. In some implementations, extruding a polygon instead of a line segment can be used to generate different hairstyles such as curls, dreadlocks, cornrows, etc. The density of the hair card (e.g., a number of segments along the U and V dimensions) can be adjusted to match the performance requirements of the platform.

In some implementations, additional curves are created by interpolating between existing user-authored curves to create more hair cards when needed to avoid gaps, or to create higher visual quality with more hair card density.

In some implementations, a third type of user device may include high performance devices with capabilities greater than devices of the first type and the second type. For example, the third type of user devices may include computing devices such as laptops, desktops (gaming devices).

In response to determining that the user device is of the third type, generating the hair geometry may include generating one or more polygonal (e.g., triangle) strips based on the plurality of curves. In some implementations, for user devices of the third type (high performance devices), a layer of hair cards that includes hair with a sparse alpha texture may be generated.

In some implementations, high level shaping controls, e.g., twisting, scaling, bending, tapering, etc., may be applied to the hair geometry if they are indicated in the hair geometry metadata, and if the feature is supported by the capabilities of the device type of the user device.

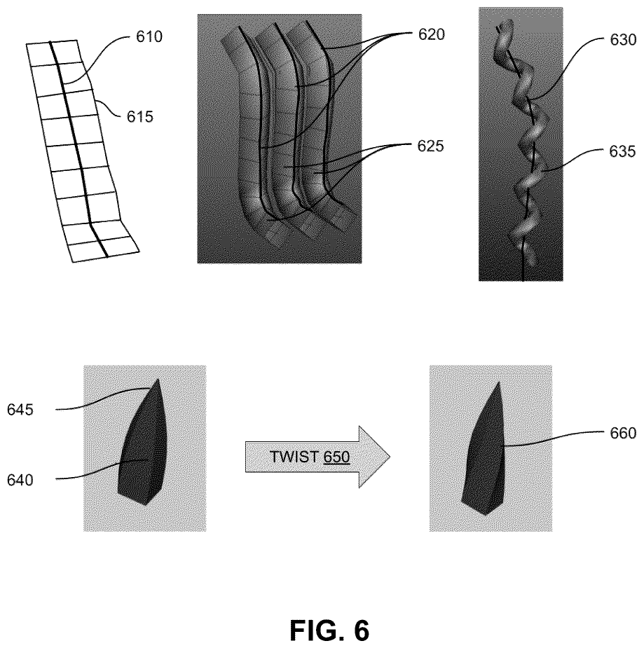

FIG. 6 depicts examples of hair features generated based on user specified curves, in accordance with some implementations.

As described earlier, based on hair geometry metadata that is specified by a develop user, hair features are modeled in the hair geometry by extruding along authored curves. The hair features may be modeled by one or more of hair cards, volumes, tubes (e.g., dreadlocks), curls, etc.

For example, as depicted in FIG. 6, hair card 615 is generated by extruding along curve 610. Similarly, tubes 625 are generated by extruding along curves 620, and a curl 635 is generated by extruding along curve 630.

FIG. 6 additionally depicts a taper 645 applied to hair object 640 as well a twist operation 650 that yields a twisted hair object 660.

In some implementations, on user devices that are determined to have the capability to support advanced rendering, an additional layer of hair cards may be utilized to provide depth, as well to depict special effects such as flyaway strands, etc.

In some implementations, generating the hair geometry may additionally include generating additional curves by interpolating between one or more pairs of curves in the plurality of curves. This enables rendering of hair with a higher density of hairs.

In some implementations, the generation technique may additionally be based on a computational load at the user device. A current computational load at the user device, e.g., current CPU utilization, current memory utilization, etc. is determined, and the generation technique for hair geometry generation is selected based on the computational load as well as the device type of the user device. In some implementations, the computational load may be directly determined based on one or more metrics of the user device. In some other implementations, the computational load may be inferred from other parameters in the virtual experience, e.g., a number of avatars that have to be rendered on the user device.

In some implementations, the generation technique may be adjusted during a session of a virtual experience. For example, a first technique may be utilized for an initial portion of a virtual experience session based on a device type of the user device and a number of avatars to be displayed initially. Subsequently, additional players may join the virtual experience, thereby increasing the computational load on participating user devices. Based on a determination of an increased computational load, a second technique (of lower complexity) for geometry generation may be utilized to generate a second hair geometry to be utilized for the next portion of the virtual experience. The simpler hair geometry may enable the meeting of real-time processing requirements, e.g., smooth rendering of hair without discontinuities, jitter, blank spot, etc., and/or for the hair motion (movement) to be congruent with head motion(s) of the avatars in the virtual experience.

In some implementations, a point of origin of the curves may be located on a mesh face of a scalp mesh. In some implementations, one curve may be utilized per mesh face, and some mesh faces may not include any attached curves.

Movement(s) of the hair or hair-like feature are aligned to movements of any underlying attached 3D objects by applying skinning from the scalp mesh to the generated hair. For example, in the case of hair for a 3D object, the scalp mesh is fitted to the head of an avatar by utilizing a cage deformer and applying skinning from the scalp mesh to the generated hair.

In some implementations, a UV map corresponding to the generated hair geometry may be generated simultaneously to the generation of the hair geometry. The UV map includes texture information associated with one or more points on a surface of the generated geometry and may be utilized to render the hair on the user device. In some implementations, the U dimension may be defined along the perimeter of the volume or width of the hair card (or hair ribbon), and the V dimension may be defined along the length of the hair card (or hair ribbon).

Block 520 may be followed by block 530.

At block 530, hair for the 3D object is simulated at the user device. In some implementations, simulating the hair may include computing a current state and/or a series of states of the hair.

In some implementations, the hair is simulated based on the hair geometry, a device type of the user device, the hair simulation metadata, and/or one or more physics parameters of the virtual experience. In some implementations, the physics parameters may include gravity, wind speed, speed and direction of movement of an avatar associated with the hair, collisions between avatar(s), collisions between avatar(s) and other 3D objects within the virtual experience, hair simulation metadata such as bounciness of hair, etc.

In some implementations the physics simulation is procedurally performed on the local user device to determine a current state of the hair. Physics parameters for the simulation are selected and applied based on developer user intent expressed in authored hair simulation metadata. In some implementations, the physics parameters may be based on a style of the hair (e.g., long hair, short hair, flowing hair, short hair, curls, dreadlocks, etc.

In addition to adjusting the physics parameters, a type of physics solver (algorithm) may also be determined based on a device type of the user device, device capabilities, and performance requirements of the user device.

In some implementations where the device type is of a first type, e.g., a user device with relatively low computational resource availability, simulating the hair for the 3D object may include performing a vertex simulation based on the hair geometry. For example, individual vertices in a vertex shader may be animated by utilizing a damped spring oscillation model that is driven based on the velocity and acceleration of a 3D object (e.g., avatar head) associated with the hair. Per-hair offsets in movement direction and magnitude may be determined by utilizing noise and vertex color data.

In some implementations, the vertex simulation may be performed by utilizing a graphical processing unit (GPU) of a user device. In some implementations, an offline strand hair simulation may be utilized for common player movements (e.g., running, jumping, strafing, etc.) and blending between different preset strand animations on the GPU.

In some implementations, movement of hair based on the laws of physics may be simulated by GPU vertex simulation. In some implementations, a full physics simulation may be performed, whereas in other implementations, approximations may be utilized. Approximations may be utilized on low-end devices as well as in scenarios where the reduced fidelity from the approximations may not be visually perceptible. A variety of approximation algorithms may be utilized.

In some implementations, a damped spring oscillation approximation may be utilized. Hair movements may be determined by determining a cosine of a dampened linear speed and time and multiplying the determined number by a scaling factor (amount). In some implementations, the scaling factor is variable and based on a position along the corresponding hair curve, e.g., 0 at the base of the curve and 1 at the tip of the curve. The interpolation function (e.g., linear, exponential, etc.) between 0 and 1 may be based on artistic intent specified via the metadata.

In some implementations, where a GPU is not available, the simulation may be omitted, and a static hair display may be rendered.

In some implementations where the device type is of a second type, e.g., a user device with increased computational resource availability when compared to the first type, simulating the hair for the 3D object may include performing a mesh simulation based on the hair geometry. In some implementations, performing a mesh simulation can include procedurally creating a mesh underneath each hair clump defined by the hair geometry. A cloth simulation is performed on the mesh, with the top of the mesh attached to the scalp mesh. A collision between the mesh against the avatar head and/or body is simulated to determine a current state of the hair clump. The hair is deformed to the cloth mesh to obtain a final state of the hair.

In some implementations, a mesh may be formed by connecting each curve to adjacent curves by connecting edges from the vertices on one curve to the vertices on adjacent curves to form the mesh. Physics forces on each vertex of the mesh may be determined by modeling each edge as a spring and such that the distance between respective vertices is maintained approximately constant. The resulting vertex deltas may be used to calculate vertex positions on the underlying curves, which would then simulate motion of the generated hair geometry.

In some implementations, where the device type is of a second type, a rope simulation may be performed to simulate the hair based on the hair model. Rope simulation entails modeling the hair as a system of particles that are constrained to move together and not as individual fibers or strands that make up the hair.

In some implementations, capsule colliders and bones may be procedurally generated along each clump where the bones are welded to the capsules. The hair geometry of each clump is skinned to the bones. Rope simulation techniques may be applied to simulate capsule colliders, using hair simulation metadata associated with the clump to define simulation parameters. Collisions of each capsule may then be simulated against the ground, parts of the associated 3D object, and/or against each other capsules.

In some implementations, rope simulation may be utilized to perform hair simulation for hairstyles that have dangling parts, e.g., ponytails, pigtails, dreadlocks, etc. Rope simulation may also be utilized in mid-range user devices where the computational resource availability for hair simulation exceeds the bare minimum (where an approximation such as a damped spring oscillation may be utilized) but is insufficient for the simulation of each hair curve.

In some implementations, rope simulation may also be performed on a low-end device, e.g., in situations where only one avatar/3D object is included as well in virtual experiences on high-end user devices (platforms) with a large number of included avatars (3D objects).

In some implementations where the device type is of a third type, e.g., a user device with increased computational resource availability when compared to the first and second types, the hair simulation may be based on hair geometry that is deformed to a simulated cloth mesh. In some implementations where the device type is of a third type, the hair simulation may include the hair simulation of individual strands (strand simulation). This provides the highest fidelity and accuracy, while being relatively resource intensive.

In such implementations, physics forces are determined for each vertex of the hair curve(s), subject to imposed internal constraints such as hair stretchiness or stiffness, and external forces such as wind, acceleration, etc.

In some implementations, a particular type of hair simulation technique may be selected based on the device type, but during the session, it may be determined that the selected technique is not suitable for the hair simulation and still meet performance requirements. For example, a user device may be executing some other applications that are utilizing significant computational resources, thereby affecting the performance of the hair simulation. In such a scenario, a fallback to a technique to a less resource intensive computational technique may be performed. For example, a user device that is utilizing strand simulation may fallback to rope simulation or GPU Vertex simulation based on a current resource utilization and a determination that a less resource intensive hair simulation technique would enable meeting real-time performance requirements.

In some implementations, the simulation of the hair may include generating multiple updates of the hair for a particular time interval and at a particular frame rate. For example, the simulation may include generating states of the hair at a rate that corresponds to a refresh rate of a display screen of the user device, e.g., 30 frames per second, 60 frames per second, etc. The matching of the simulation rate to a display rate of the user device may provide additional computational efficiency due to the use of procedural simulation (as opposed to simulating at a server or other device) since excess data need not be generated. Additionally, superior user experience may be provided for devices with higher processing power that may utilize the same hair model and/or geometry and perform higher frequency updates.

Block 530 may be followed by block 540.

At block 540, the 3D object along with the simulated hair may be rendered on the user device.

In some implementations, a rendering technique may be based on the device type of the user device and/or computational load on the user device. Materials and textures are procedurally applied based on the user intent defined in the authored metadata. Textures can be procedurally generated based on UV maps that are determined during hair geometry determination. Different shading techniques can be used based on performance requirements and user device capabilities.

In some implementations where the device type is of a first type, e.g., a user device with relatively low computational resource availability, the rendering may include a basic rendering without any special effects. For example, a low-end platform may apply a basic material that does not use an anisotropic highlight.

In some implementations where the device type is of a second type or a third type, e.g., with increased computational resource availability compared to devices of the first type, the rendering of the simulated hair may include rendering the simulated hair using an anisotropic highlight material. In some implementations, depending on device capability, other visual effects may be included for rendering, e.g., realtime lighting and light transmission estimation, surface scattering, shadows, etc. In some implementations, the rendering may include rendering hair using a Kajiya Kay and/or Marschner model.

In some implementations, color for hair is procedurally determined and applied at a time of rendering at the user device. In some implementations a developer user (creator) defines one or more default colors for the hairstyle, and assigns them to clumps (ColorClumps) to determine assignment of colors to different portions of the hair. In some implementations, the developer user can specify that the colors are fixed for the hairstyle. In some other implementations, the developer user can specify that the colors can be customized by the user (e.g., player).

In some implementations, for customizable hair, a developer user can specify a default palette of colors that the user can select from. In some implementations, for customizable hair, a user may be able to select a color of their choice. A developer user may also specify a price (e.g., in terms of virtual currency) for use selection of colors from a palette.

In some implementations, during rendering of the hair, color may be applied to hair by multiplying the color against a base grayscale color, blending to a slightly darker color at the root of the hair. If multiple colors are selected, a color gradient may be utilized to blend between the multiple colors. In some implementations, hairstyles with interleaved strands may support up to six colors (one color gradient pair per color channel).

In some implementations, real-time monitoring of user device performance may be utilized to adjust an LOD for hair and hair-like features. For example, if it is determined at runtime that a realized frame rate (e.g., frames per second) at the user device is lower than that needed for rendering the frames at a threshold frame rate, one or more hair features may be deactivated (turned off). Similarly, one or more hair features may be deactivated if it is determined that the 3D object (e.g., avatar) associated with the hair is occupying a relatively small area of the screen, and/or if it is determined that the 3D object (e.g., avatar) associated with the hair is outside the view frustum.

Method 500, or portions thereof, may be repeated any number of times using additional inputs. Blocks 510-540 may be performed (or repeated) in a different order than described above and/or one or more steps can be omitted. Additionally, the blocks may be performed at different rates. For example, block 510 and block 520 may be performed at a frequency (rate) that is different from a rate at which blocks 530 and 540 are performed. Block 510 may be performed once per user device to obtain the hair model during initialization of a virtual experience. Block 520 may be performed periodically to adjust the hair geometry (if needed) based on an evaluation of a computational load. Blocks 530 and 540 may be performed to match a refresh rate of the user device.

FIG. 7 depicts an example hair editor for the design of virtual hair and hair-like features, in accordance with some implementations.

FIG. 7 illustrates an example of a hair editor 710 that may be included in a virtual experience development environment (developer tool), in accordance with some implementations. The virtual experience development environment may provide a user interface that enables a developer user to design and/or create virtual experiences, e.g., games. The virtual experience development environment may be a client-based tool (e.g., downloaded and installed on a client device, and operated from the client device), a server-based tool (e.g., installed and executed at a server that is remote from the client device, and accessed and operated by the client device), or a combination of both client-based and service-based elements.

The hair editor 710 may be operated by a developer of a virtual experience, e.g., a game developer or any other person who seeks to create a hairstyle that may be published by an online virtual experience platform and utilized by others. The user interface of the hair editor may be rendered on a display screen of a client device, e.g., such as a developer device 130 described with reference to FIG. 1, so as to enable the creator/developer to interact with the development environment using actions such as typing, highlighting, selecting, drag and drop, clicking, and so forth via a mouse, keyboard, or other input device configured to communicate with the user interface. The user interface may include a menu bar, a tool bar, a workspace pane, and a plurality of secondary panes. Depending on the particular implementation, the user interface may include alternative or additional elements, arrangements, operational features, etc. of the virtual experience development environment than what is shown and described herein with respect to in FIG. 7. Thus, it is understood that the various elements and operation of the example virtual experience development environment and user interface shown in FIG. 7 are for purposes of illustration and explanation herein and that variations/modifications thereof are possible.

A developer user (creator) may utilize the virtual experience development environment to create hair designs and hair-like features. As part of the development process, the developer/creator may upload various types of digital content such as image files, text prompts, etc., to enhance the virtual experience.

The hair editor 710 may include a display window 770 for the visualization of a created hairstyle. Additionally, hair editor 710 includes elements for the design and specification of a hair model. For example, the hair editor 710 includes elements for the specification of curves 720, tools for manipulating hair 730, elements for providing metadata 750, and elements for differentiation of hair regions using layers/clumps 760. Avatar head 775 is also depicted, which includes the scalp mesh that is an origin for the hair strands.

In this illustrative example, hair curves 720 includes Curve 1 (720a), Curve 2 (720b), and Curve N (720n). The corresponding hair strands are displayed on the display window 770 as curves 780a, 780b, and 780n.

The hair editing tools are designed to resemble real-world hair tools and to implement real-life styling concepts, to enable a developer user to easily translate user intent regarding a hairstyle into hair design.

In some implementations, tools may be provided in the hair editor to specify a set of curves and associated metadata. Additionally, tools may be provided to edit and modify the set of curves, to increase length, reduce length, adjust the shape of the curve, etc.

In some other implementations, additional functionality may be provided to automatically generate a set of curves based on images, e.g., sketches, photographs, etc. This can enable a developer user to recreate an existing design or style from another source. Additionally, a set of basic hair models (hairstyles) can be provided within the hair editor 710 and creators can kitbash (e.g., select from one or more existing hair models) and modify hair models.

In some implementations, the layers/clumps tool can be utilized to build independent hair layers, e.g., a braid layer, a front bang layer, a top layer, etc. Each layer is modeled as an independent hair object that can be provided to hair simulation algorithms independently. In some implementations, a library of layers can be included in hair editor 710 from which develop users can assemble a hairstyle by selecting one or more layers from the library of layers that can be combined with user created layers. In some implementations, prebuilt hair textures may be provided for users to choose for each clump and/or layer.

The tools for manipulating hair 730 to generate a hair model include a variety of tools; a pull hair tool that enables a user to move a hair tip that causes the rest of the hair (curve) to also move; a scissors tool that enables a user to cut the hair curve at a particular position; a brush tool to bend hair (and adjust the underlying hair curve); a clippers tool to cut a set of hair curves to a given length; an extender tool to pull a hair curve and extend its length; a straighten tool to enable a user to straighten hair from root to tip, a twist tool that twists hair from root to tip; a bend tool; a mirror tool that enables copying of a portion of hair to another region.

As described earlier, portions of the hair may be differentiated into clumps for the purposes of simulation and/or rendering. Separate clumps may be partitioned for application of color (ColorClump) or for simulation of movement (SimulationClump).

In some implementations, a stretch/relaxation tool element may be provided to perform a physics simulation that can be utilized to relax the hair under effects of gravity.

In some implementations, advanced hair creation tools may be provided for generation of curves. For example, a user may be able to upload a sketch of a hairstyle, e.g., a rough sketch of hair over a reference photograph. The hair creation tool may be utilized to convert the sketch and hair to a set of hair curves. In some implementations, the advanced hair creation tool may include features that enable a user to generate a set of curves based on a combination of images and/or text prompts. A trained machine learning (ML) model may be utilized to aid in the generation of hair curves.

The hair editor 710 also includes features that enable a user to preview the hair geometry and hairstyle. Hair motion may also be previewed based on preset animations. Users may be able to preview the hair under different animation routines, e.g., running, dancing, etc., and adjust metadata, e.g., hair simulation metadata, hair geometry metadata, etc.

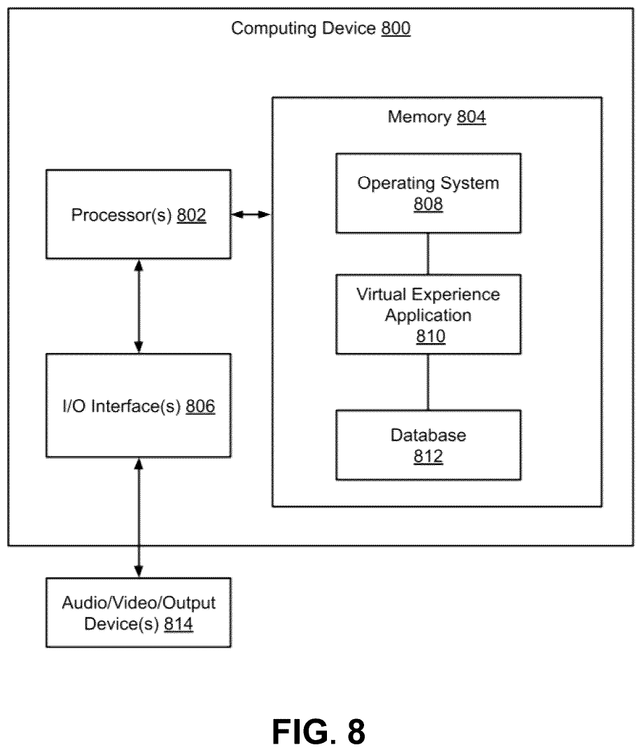

FIG. 8 illustrates an example computing device, in accordance with some implementations.

In one example, device 800 may be used to implement a computer device (e.g., 102, 110, and/or 130 of FIG. 1), and perform suitable method implementations described herein. Computing device 800 can be any suitable computer system, server, or other electronic or hardware device. For example, the computing device 800 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 800 includes a processor 802, a memory 804, input/output (I/O) interface 806, and audio/video input/output devices 814.

Processor 802 can be one or more processors, processing devices, and/or processing circuits to execute program code and control basic operations of the device 800. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 804 is typically provided in device 800 for access by the processor 802, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 802 and/or integrated therewith. Memory 804 can store software operating on the server device 800 by the processor 802, including an operating system 808, one or more applications 810, e.g., an audio spatialization application, a sound application, content management application, and application data 812. In some implementations, application 810 can include instructions that enable processor 802 to perform the functions (or control the functions of) described herein, e.g., some or all of the methods described with respect to FIG. 5

For example, applications 810 can include an audio spatialization module which as described herein can provide audio spatialization within an online virtual experience server (e.g., 102). Any software in memory 804 can alternatively be stored on any other suitable storage location or computer-readable medium. In addition, memory 804 (and/or other connected storage device(s)) can store instructions and data used in the features described herein. Memory 804 and any other type of storage (magnetic disk, optical disk, magnetic tape, or other tangible media) can be considered “storage” or “storage devices.”

I/O interface 806 can provide functions to enable interfacing the server device 800 with other systems and devices. For example, network communication devices, storage devices (e.g., memory and/or data store 812), and input/output devices can communicate via interface 806. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 814 can include a user input device (e.g., a mouse, etc.) that can be used to receive user input, a display device (e.g., screen, monitor, etc.) and/or a combined input and display device, that can be used to provide graphical and/or visual output.

For case of illustration, FIG. 8 shows one block for each of processor 802, memory 804, I/O interface 806, and software blocks 808 and 810. These blocks may represent one or more processors, processing devices, or processing circuitries, operating systems, memories, I/O interfaces, applications, and/or software engines. In other implementations, device 800 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the device 800, e.g., processor(s) 802, memory 804, and I/O interface 806. An operating system, software and applications suitable for the user device can be provided in memory and used by the processor. The I/O interface for a user device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 814, for example, can be connected to (or included in) the device 800 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., method 500, etc.) can be implemented by computer program instructions or code, which can be executed on a computer. For example, the code can be implemented by one or more digital processors (e.g., microprocessors or other processing circuitry), and can be stored on a computer program product including a non-transitory computer-readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a user device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method, comprising:
receiving, at a user device that participates in a virtual experience, a hair model for a three-dimensional (3D) object, wherein the hair model includes a plurality of curves, hair geometry metadata associated with one or more curves of the plurality of curves, and hair simulation metadata;
generating, at the user device, hair geometry for the 3D object based on the hair model, the hair geometry metadata, and a type of the user device;
simulating, at the user device, hair for the 3D object based on the hair geometry, the hair simulation metadata, and one or more physics parameters of the virtual experience; and
rendering the 3D object with the simulated hair on the user device.

2. The computer-implemented method of claim 1, further comprising:
determining that the user device is of a first type; and
wherein, in response to determining that the user device is of the first type, generating the hair geometry comprises generating a geometry shell that encompasses the plurality of curves.

3. The computer-implemented method of claim 1, further comprising:
determining that the user device is of a second type; and
wherein, in response to determining that the user device is a device of the second type, generating the hair geometry comprises generating a plurality of hair cards, wherein each hair card corresponds to a respective curve of the plurality of curves by extruding, along the respective curve, one of: a line segment and a polygon strip.

4. The computer-implemented method of claim 3, wherein the extruding comprises extruding along the respective curve based on the hair geometry metadata associated with the curve to create one or more of a hair card, a tube, or a curl.

5. The computer-implemented method of claim 1, further comprising:
determining that the user device is of a third type; and
wherein, in response to determining that the user device is a device of the third type, generating the hair geometry comprises generating one or more triangle strips based on the plurality of curves.

6. The computer-implemented method of claim 5, further comprising creating a layer of hair cards that includes hair with a sparse alpha texture.

7. The computer-implemented method of claim 1, wherein generating the hair geometry comprises generating one or more additional curves by interpolating between one or more pairs of curves in the plurality of curves.

8. The computer-implemented method of claim 1, wherein each curve of the plurality of curves is attached to a mesh face of a scalp mesh that can be fitted to the 3D object.

9. The computer-implemented method of claim 1, further comprising:
determining a device type; and
selecting, based on the device type, a generation technique to generate the hair geometry, wherein the generation technique is one of:
generating a geometry shell that encompasses the plurality of curves;
generating a plurality of hair cards, wherein each hair card corresponds to a respective curve of the plurality of curves; or
generating one or more polygonal strips based on the plurality of curves.

10. The computer-implemented method of claim 9, wherein the device type is of a first type, and wherein the simulating the hair for the 3D object comprises performing a vertex simulation based on the hair geometry.

11. The computer-implemented method of claim 9, wherein the device type is of a second type, and wherein the simulating the hair for the 3D object comprises performing a mesh simulation based on the hair geometry.

12. The computer-implemented method of claim 9, further comprising:
determining a computational load on the user device; and wherein selecting the generation technique is further based on the computational load.

13. The computer-implemented method of claim 12, further comprising receiving, during the virtual experience, an indication of a change in the computational load, and wherein the method further comprising re-generating the hair geometry based on the change in the computational load.

14. The computer-implemented method of claim 1, further comprising procedurally generating a UV map corresponding to the generated hair geometry, wherein the UV map includes texture information associated with one or more points on a surface of the generated hair geometry.

15. A non-transitory computer-readable medium with instructions stored thereon that, responsive to execution by a processing device, cause the processing device to perform operations comprising:
receiving, at a user device that participates in a virtual experience, a hair model for a 3D object, wherein the hair model includes a plurality of curves, hair geometry metadata associated with one or more curves of the plurality of curves, and hair simulation metadata;
generating, at the user device, hair geometry for the 3D object based on the hair model, the hair geometry metadata, and a type of the user device;
simulating, at the user device, hair for the 3D object based on the hair geometry, the hair simulation metadata, and one or more physics parameters of the virtual experience; and
rendering the 3D object with the simulated hair on the user device.

16. The non-transitory computer-readable medium of claim 15, wherein the operations further comprise:
determining a device type; and
selecting, based on the device type, a generation technique to generate the hair geometry, wherein the generation technique is one of:
generating a geometry shell that encompasses the plurality of curves;
generating a plurality of hair cards, wherein each hair card corresponds to a respective curve of the plurality of curves; or
generating one or more polygonal strips based on the plurality of curves.

17. The non-transitory computer-readable medium of claim 15, wherein the operations further comprise:
procedurally generating a UV map corresponding to the generated geometry, wherein the UV map includes texture information associated with one or more points on a surface of the generated geometry.

18. A system comprising:
a memory with instructions stored thereon; and
a processing device, coupled to the memory, the processing device configured to access the memory and execute the instructions, wherein the instructions cause the processing device to perform operations comprising:
receiving, at a user device that participates in a virtual experience, a hair model for a 3D object, wherein the hair model includes a plurality of curves, hair geometry metadata associated with one or more curves of the plurality of curves, and hair simulation metadata;
generating, at the user device, hair geometry for the 3D object based on the hair model, the hair geometry metadata, and a type of the user device;
simulating, at the user device, hair for the 3D object based on the hair geometry, the hair simulation metadata, and one or more physics parameters of the virtual experience; and
rendering the 3D object with the simulated hair on the user device.

19. The system of claim 18, wherein the operations further comprise:
determining that the user device is of a first type; and
wherein, in response to determining that the user device is of the first type, generating the hair geometry comprises generating a geometry shell that encompasses the plurality of curves.

20. The system of claim 18, wherein the operations further comprise:
determining that the user device is of a second type; and
wherein, in response to determining that the user device is a device of the second type, generating the hair geometry comprises generating a plurality of hair cards, wherein each hair card corresponds to a respective curve of the plurality of curves by extruding, along the respective curve, one of: a line segment and a polygon strip.
